(19) United States
(12) Patent Application Publication
(10) Pub. No.: US 2026/0080183 A1
(43) Pub. Date: Mar. 19, 2026

(54) Adaption of Large Language Model Answers

(71) Applicant: Google LLC, Mountain View, CA (US)

(72) Inventors: Victor Carbune, Zurich (CH); Matthew Sharifi, Kilchberg (CH)

(73) Assignee: Google LLC, Mountain View, CA (US)

(21) Appl. No.: 18/888,107

(22) Filed: Sep. 17, 2024

(51) Int. Cl. G06F 40/40

(52) U.S. Cl. CPC G06F 40/40

(57) ABSTRACT

A method includes receiving a natural language query directed toward an assistant large language model (LLM) specifying a particular action for the assistant LLM to perform. The method also includes generating, using the assistant LLM, presentation content based on performing the action specified by the natural language query and receiving a user input indication indicating selection of a target application after generating the presentation content. The method also includes adapting the presentation content generated by the assistant LLM based on the selected target application and providing the adapted presentation content for input to the selected target application.

### TECHNICAL FIELD

This disclosure relates to adaption of large language model (LLM) answers.

### BACKGROUND

Large language models are increasingly used to provide conversational experiences between users and digital interfaces executing on user devices. In general, a user provides a query/prompt to the LLM in natural language that requests information and the LLM generates, based on the query/prompt, a response conveying the requested information. As LLMs are currently opening up a wide range of applications due to their powerful understanding and generation capabilities which can operate over text, image, and/or audio inputs, LLMs are becoming customized to operate and provide specific services for users.

### SUMMARY

One aspect of the disclosure provides a computer-implemented method that when executed on data processing hardware causes the data processing hardware to perform operations for adapting LLM answers. The operations include receiving a natural language query directed toward an assistant large language model (LLM) from a user device associated with a user. The natural language query specifies a particular action for the assistant LLM to perform. The operations also include generating, using the assistant LLM, presentation content based on performing the action specified by the natural language query. After generating the presentation content, the operations include receiving a user input indication from the user device indicating a selection of an application. The operations also include adapting the presentation content generated by the assistant LLM based on the selected application. The operations also include providing the adapted presentation content for input to the selected application.

Implementations of the disclosure may include one or more of the following optional features. In some implementations, the operations further include extracting, from the selected target application, a target content for inputting the presentation content into the selected target application and determining a prompt for input to the assistant LLM based on the presentation content and the target context. Here, adapting the presentation content includes processing the prompt to generate the adapted presentation content using the assistant LLM. In these implementations, the presentation content may include a textual representation, the target context indicates an audio context for inputting the presentation content to the selected target application, and the adapted presentation content includes a synthetic speech representation. The assistant LLM may include a multimodal LLM. In these implementations, the presentation content may include a textual representation, the target context includes a textual context for inputting the presentation content to the selected target application and the adapted presentation content includes another textual representation different than the textual representation of the presentation content.

In some examples, the operations further include providing the adapted presentation content for output from the user device before providing the adapted presentation content for input to the selected target application, receiving a follow-on query specifying one or more refinement actions for the adapted presentation content, generating refined presentation content based on the adapted presentation content and the follow-on query, and providing the refined presentation content for input to the selected target application. In these examples, generating the refined presentation content may include processing a concatenation of the adapted presentation content and the follow-on query using the assistant LLM. In some implementations, the operations further include providing the adapted presentation content for output from the user device before providing the adapted presentation content for input to the selected target application and receiving a confirmation response from the user device confirming input of the adapted presentation content into the selected target application. Here, providing the adapted presentation content for input to the selected target application is based on receiving the confirmation response from the user device.

The natural language query may further specify the target application for the presentation content. In some examples, the operations further include obtaining data representing the selected target application displayed on a screen of the user device based on receiving the user input indication from the user device, determining a score indicating a likelihood that the user intends input the presentation content to the selected target application based on the obtained data representing the selected target application, and determining that the score satisfies a threshold. Here, providing the adapted presentation content for input to the selected target application is based on determining that the score satisfies the threshold. In these examples, obtaining the data representing the selected target application includes at least one of extracting text from the selected target application displayed on the screen of the user device or extracting metadata from one or more user interface elements of the selected target application displayed on the screen of the user device.

Another aspect of the disclosure provides a system that includes data processing hardware and memory hardware storing instructions that when executed on the data processing hardware causes the data processing hardware to perform operations. The operations include receiving a natural language query directed toward an assistant large language model (LLM) from a user device associated with a user. The natural language query specifies a particular action for the assistant LLM to perform. The operations also include generating, using the assistant LLM, presentation content based on performing the action specified by the natural language query. After generating the presentation content, the operations include receiving a user input indication from the user device indicating a selection of an application. The operations also include adapting the presentation content generated by the assistant LLM based on the selected application. The operations also include providing the adapted presentation content for input to the selected application.

Implementations of the disclosure may include one or more of the following optional features. In some implementations, the operations further include extracting, from the selected target application, a target content for inputting the presentation content into the selected target application and determining a prompt for input to the assistant LLM based on the presentation content and the target context. Here, adapting the presentation content includes processing the prompt to generate the adapted presentation content using the assistant LLM. In these implementations, the presentation content may include a textual representation, the target context indicates an audio context for inputting the presentation content to the selected target application, and the adapted presentation content includes a synthetic speech representation. The assistant LLM may include a multimodal LLM. In these implementations, the presentation content may include a textual representation, the target context includes a textual context for inputting the presentation content to the selected target application and the adapted presentation content includes another textual representation different than the textual representation of the presentation content.

In some examples, the operations further include providing the adapted presentation content for output from the user device before providing the adapted presentation content for input to the selected target application, receiving a follow-on query specifying one or more refinement actions for the adapted presentation content, generating refined presentation content based on the adapted presentation content and the follow-on query, and providing the refined presentation content for input to the selected target application. In these examples, generating the refined presentation content may include processing a concatenation of the adapted presentation content and the follow-on query using the assistant LLM. In some implementations, the operations further include providing the adapted presentation content for output from the user device before providing the adapted presentation content for input to the selected target application and receiving a confirmation response from the user device confirming input of the adapted presentation content into the selected target application. Here, providing the adapted presentation content for input to the selected target application is based on receiving the confirmation response from the user device.

The natural language query may further specify the target application for the presentation content. In some examples, the operations further include obtaining data representing the selected target application displayed on a screen of the user device based on receiving the user input indication from the user device, determining a score indicating a likelihood that the user intends input the presentation content to the selected target application based on the obtained data representing the selected target application, and determining that the score satisfies a threshold. Here, providing the adapted presentation content for input to the selected target application is based on determining that the score satisfies the threshold. In these examples, obtaining the data representing the selected target application includes at least one of extracting text from the selected target application displayed on the screen of the user device or extracting metadata from one or more user interface elements of the selected target application displayed on the screen of the user device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for adapting presentation content generated by an assistant large language model (LLM).

FIG. 2 is a schematic view of determining a prompt for the assistant LLM to process to generate adapted presentation content.

FIGS. 3A and 3B are schematic views of a user device while adapting presentation content generated by the assistant LLM.

FIG. 4 is a flowchart of an example arrangement of operations for adapting LLM answers.

FIG. 5 is a schematic view of an example computing device that may be used to implement the systems and methods described herein.

Like reference symbols in the various drawings indicate like elements.

### DETAILED DESCRIPTION

Humans may engage in human-to-computer dialogs with interactive software applications referred to as “chatbots,” “voice bots,” “automated assistants,” “interactive personal assistants,” “intelligent personal assistants,” “conversational agents,” etc. via a variety of computing devices. As one example, chatbots may correspond to a machine learning model or a combination of different machine learning models and may be utilized to perform various tasks on behalf of users. Chatbots adopting large language models (LLMs) are currently opening up a wide range of applications due to their powerful understanding and generation capabilities which can operate over test, image, and/or audio inputs. These models are also being extended with actuation capabilities via integration mechanisms with various service providers.

In some scenarios, users query or prompt chatbots adopting LLMs by speaking a natural language query or providing a textual input whereby the chatbots generate a response based on the query or prompt. Thereafter, the user may input the generated response into another application executing on a user device. In one example, a user prompts the chatbot to generate language for an email and then manually inputs the response generated by the chatbot (e.g., by copying and pasting the response) that includes the language for the email into an email application. In another example, a user prompts the chatbot to generate or edit code and then manually inputs the response generated by the chatbot that includes the generated or edited code into a programming environment. Moreover, users may need to modify the response generated by the chatbots to fit a target context of another application. For instance, the user may have to modify the language for the email generated by the chatbot to conform with a conversational style of one or more previous emails or modify the generated code to conform with a programming language used in the programming environment. In short, responses generated by chatbots oftentimes require further user input to input the responses into a target application and may even require the user to modify the response to fit the target context of the target application.

To that end, implementations herein are directed towards a method and system of adapting LLM answers. In particular, the method includes receiving a natural language query directed toward an assistant large language model (LLM) from a user device associated with a user. The natural language query may be spoken by the user and/or provided as a textual input by the user. The assistant LLM processes the natural language query to generate presentation content based on performing the action specified by the natural language query. The presentation content may be output from the user device by displaying a textual representation of the presentation content and/or audibly outputting the presentation content. After generating the presentation content, the method includes receiving a user input indication from the user device that indicates a selection of an application. For example, after observing the presentation content, the user may select another application that is executed and displayed by the user device. As will become apparent, the selected application may be an application that the user wants to input the presentation content, or some variation thereof, into by copying and pasting the presentation content. The method also includes adapting the presentation content generated by the assistant LLM based on the selected application and providing the adapted presentation content for input to the selected application.

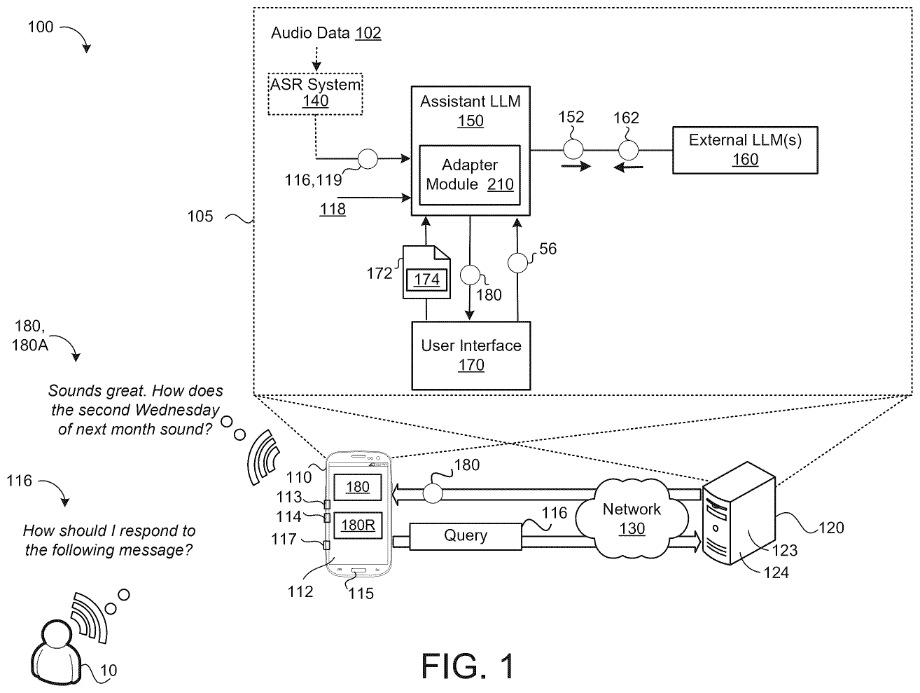

FIG. 1 illustrates an example system 100 including a large language model (LLM) adaptation system 105 that adapts answers/responses (i.e., presentation content 180) generated by an assistant LLM 150 to conform to a target context of a user device 110. Generally, a user 10 inputs, via the user device 110, a natural language query 116 to the assistant LLM 150 specifying a particular action or task the user 10 wants the assistant LLM 150 to perform on behalf of the user 10. Here, the assistant LLM 150 may process the natural language query 116 by performing query interpretation to ascertain the particular action or task to be performed. The natural language query 116 may be spoken by the user 10 or provided as a textual representation.

Based on performing the action specified by the natural language query 116, the assistant LLM 150 may generate presentation content 180. In some examples, the assistant LLM 150 generates the presentation content 180 as an intermediate output such that the presentation content 180 is not output from the user device 110. In other examples, the assistant LLM 150 generates the presentation content 180 for output from the user device 110. The user device 110 may audibly output, from an audio output device (e.g., acoustic speaker) 117, the presentation content 180 as synthesized speech. Additionally or alternatively, the user device 110 may display, on a screen 112 in communication with the user device 110, graphics, text, and/or other visual information that conveys the details of the presentation content 180.

The LLM adaptation system 105 includes the user device 110, a remote computing system 120, and a network 130. The user device 110 includes data processing hardware 113 and memory hardware 114. The user device 110 may include, or be in communication with, an audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query 116 via a user interface 170 executing on the user device 110.

In scenarios when the user 10 speaks a natural language query 116 captured by the microphone 115 of the user device 110, an automated speech recognition (ASR) system 140 executing on the user device 110 or the remote computing system 120 may process the corresponding audio data 102 to generate a transcription of the natural language query 116. Here, the transcription conveys the natural language query 116 as a textual representation for input to the assistant LLM 150. The ASR system 140 may implement any number and/or type(s) of past, current, or future speech recognition systems, models and/or methods including, but not limited to, an end-to-end speech recognition model, such as streaming speech recognition models having recurrent neural network-transducer (RNN-T) model architecture, a hidden Markov model, an acoustic model, a pronunciation model, a language model, and/or a naïve Bayes classifier. In scenarios when the user 10 inputs the textual representation of the natural language query 116 via the user interface, the textual representation of the natural language query 116 is provided as input to the assistant LLM 150.

The user device 110 may be any computing device capable of communication with the remote computing system 120 via the network 130. The user device 110 includes, but is not limited to, desktop computing device and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the LLM adaptation system (i.e., adaption system) 105 may include the ASR system 140, the assistant LLM 150, one or more external LLMs 160, and the user interface 170. The ASR system 140 may be optional or only leveraged when the user 10 prefers spoken input of the natural language queries 116 as opposed to typed input of the natural language queries 116. In some implementations, the LLM adaptation system 105 executes on both the data processing hardware 113 of the user device 110 and the data processing hardware 123 of the remote computing system 120. For instance, one or more components of the LLM adaptation system 105 may execute on the data processing hardware 113 of the user device 110 while one or more other components of the LLM adaptation system 105 may execute on the remote computing system 120.

In some implementations, the assistant LLM 150 interacts with different external LLMs 160 of the LLM adaptation system 105 that execute across a diverse set of remote computing systems operated by different service providers. That is, the assistant LLM 150 may generate a prompt 152 based on the natural language query 116 and transmit the prompt 152 to one or more of the external LLMs 160 to perform the action specified by the natural language query 116. After issuing the respective prompt 152 to each of the one or more external LLMs 160, the assistant LLM 150 receives from the one or more external LLMs 160, response content 162 conveying details regarding performance of the action specified by the natural language query 116. Here, the assistant LLM 150 generates the presentation content 180 for output from the user device 110 based on the response content 162 received from the one or more external LLMs 160. In some examples, the assistant LLM 150 performs the action specified by the natural language query 116 in addition to, or in lieu of, interacting with the one or more external LLMs 160. That is, the assistant LLM 150 may perform the action specified by the natural language query 116 using the assistant LLM 150 and/or by interacting with the one or more external LLMs 160.

A particular entity may develop and offer its own version of an external LLM 160 that is backed by a particular cloud service provider. For example, a business or application developer may develop an external LLM 160 for interacting with a search engine application while another business or application developer may develop another external LLM 160 for interacting with a chatbot application. Thus, a first external LLM 160 offered by a first entity may be contracted through a first cloud service provider while a second external LLM 160 offered by a second entity may be contracted through a second cloud service provider. In this example, the first external LLM 160 may include a first pre-trained LLM (e.g., Google Cloud LLM) customized for the first entity that includes a far greater number of LLM parameters (e.g., 540 billion parameters) than a number of LLM parameters (e.g., 11 billion parameters) of the second external LLM 160 that includes a second pre-trained LLM (e.g., Ascenty LLM) customized for the second entity. Here, the first entity may provide training samples that include training prompts paired with corresponding ground-truth responses to create the first external LLM 160 as a customized version of the first pre-trained LLM. Similarly, the second entity may provide its own training samples that include training prompts paired with corresponding ground-truth responses to create the second external LLM 160 as a customized version of the second pre-trained LLM.

The training, or more specifically, the customization process for creating an external LLM 160 may lead to each entity having different LLM capabilities. Moreover, each LLM may have multiple capabilities whereby, depending on the prompt 152, the LLM performs a particular one of the multiple capabilities. For instance, the customization process may include various levels that serve to customize the resulting external LLM 160 with distinct capabilities. Additionally, the assistant LLM 150 and/or any of the external LLMs 160 may have the ability to perform retrieval augmented generation (RAG). While the number of LLM parameters, available plug-ins, and/or application programming interfaces (APIs) offered by each particular cloud service provider may constrain the LLM capabilities of the resulting external LLM 160, various training techniques, such as fine-tuning, prompt-tuning, and/or reinforcement learning (RL) fine-tuning may provide additional level of customization of the LLM capabilities offered by the external LLM 160. For instance, an entity may use few-shot learning to create a customized version of an existing pre-trained LLM offered by a cloud service provider. On the other hand, prompt-tuning may be implemented to learn how to create soft prompts that guide an existing pre-trained LLM offered by the cloud service provider to provide responses customized for the entity while parameters of the pre-trained LLM are held fixed. That is, an entity may fine-tune (e.g., few-shot examples, soft prompts via prompt-tuning, and/or separate adapter weights) inputs external to an existing pre-trained LLM that is already capable of being utilized in conducting more generalized conversation and/or for fine-tuning prompts input to the existing pre-trained LLM without fine-tuning the pre-trained LLM.

In some implementations, the assistant LLM 150 is personalized for the user 10. The assistant LLM 150 may function as a personal chatbot capable of having dialog conversations with the user 10 in natural language and performing tasks/actions on the user's behalf. In some examples, the assistant LLM 150 includes an instance of Bard, LaMDA, BERT, Meena, ChatGPT, Llama, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters. Accordingly, in implementations where the assistant LLM 150 is an instance of a previously-trained LLM fine-tuned locally at the user device 110, the previously trained LLM that is obtained and fine-tuned to provide the assistant LLM 150 personalized for the user 10 may be a sparse version of the previously trained LLM. In contrast, in implementations where the assistant LLM 150 is an instance of the previously trained LLM fine-tuned remotely from the client device, the previously trained LLM that is obtained and fine tuned to provide the assistant LLM 150 may be a dense version of the previously trained LLM. The sparse version of the previously trained LLM may have fewer layers, fewer parameters, masked weights, and/or other sparse aspects to reduce the size of the previously trained LLM due to various hardware constraints and/or software constraints at the user device 110 compared to the virtually limitless resources of the remote computing system 120.

The assistant LLM 150 allows unstructured free-form natural language input that conveys the details of the actions/tasks to be performed but does not define any corresponding dialog state map (e.g., does not define any dialog states or any dialog state transitions). For example, the natural language query 116 may request the assistant LLM 150 to book a flight and a hotel to a particular city for specified dates. Alternatively, the natural language query 116 may request the assistant LLM 150 to provide information on a particular topic. In yet another example, the natural language query 116 may request the assistant LLM 150 to instruct another device to perform an action, such as requesting a smart light to turn on or off. In some examples, in response to receiving the natural language query 116 as the unstructured free-form natural language input, the assistant LLM 150 interacts with an external LLM 160 that is capable of performing an action/task specified by the natural language query 116 by structuring a prompt 152 for input to the external LLM 160 that causes the external LLM 160 to perform the action/task on behalf of the user 10. The external LLM 160 may return response content 162 to the assistant LLM 150 that conveys the details of the action task/performed and the assistant LLM 150 may provide presentation content 180 for output from the user device 110 that serves as a response to the natural language query 116 by conveying information associated with the response content 162 returned from one or more external LLMs 160. The assistant LLM 150 may determine the presentation content 180 based on the response content 162 provided by each external LLM 160 that performed a corresponding portion of the action on behalf of the user 10. Further, the presentation content 180 may include, for example, a corresponding result of one or more tasks performed by the external LLM 160s or the assistant LLM 150, a corresponding summary of the corresponding tasks, and/or other content.

In other examples, in response to receiving the natural language query 116 as the unstructured free-form natural language input, the assistant LLM 150 performs actions or portions of actions, on behalf of the user 10 without the need to interact with any external LLMs 160. That is, the assistant LLM 150 may generate the presentation content 180, or portions of the presentation content 180, without interacting with any of the external LLMs 160 when the assistant LLM 150 is capable of performing the action/task specified by the natural language query 116. In some implementations, the assistant LLM 150 includes a conventional virtual digital assistant that does not utilize LLM functionality but may use heuristic/rules to interoperate with the external LLMs 160 for performing actions on behalf of the user 10.

The assistant LLM 150 generates the presentation content 180 based on performing the action/task specified by the natural language query 116. The action/task may be performed by the assistant LLM 150 itself and/or one or more of the external LLMs 160. In some examples, the presentation content 180 serves as an intermediate output that is not output on the user device 110. In other examples, the presentation content 180 is output from the user device 110 such that the presentation content 180 serves as a response to the natural language query 116 initially input by the user 10 to the assistant LLM 150. In some scenarios, the assistant LLM 150 refines or filters the presentation content 180 to provide a personalized output for the user 10. In these scenarios, the assistant LLM 150 may have knowledge of user preferences or past interactions between the user 10 and the assistant LLM 150.

In some implementations, the natural language query 116 includes or specifies query content 118 associated with the action specified by the natural language query 116. That is, the query content 118 may provide the assistant LLM 150 with further context to generate the presentation content 180. Thus, the assistant LLM 150 may process the query content 118 in addition to processing the natural language query 116 to generate the presentation content 180. The query content 118 may include one or more documents, additional audio data, image data, etc. In one example, the natural language query 116 requests the assistant LLM 150 to summarize the contents of a document whereby the query content 118 includes the document and/or specifies a location of the document. In another example, the natural language query 116 requests the assistant LLM 150 to generate a caption for an image whereby the query content 118 includes the image or specifies a location of the image. In yet another example, the natural language query requests the assistant LLM 150 to generate synthetic speech with particular voice characteristics (e.g., pitch, prosody, tone, language, etc.) whereby the query content 118 includes sample audio data including the particular voice characteristics or an embedding representing the particular voice characteristics. Accordingly, the assistant LLM 150 (and each external LLM 160) may include a multimodal LLM configured to process audio, textual, and image inputs and generate audio, textual, and image outputs.

The user interface 170 may audibly output the presentation content 180 as a synthesized speech representation responsive to the natural language query 116. Here, the user interface 170 may access a text-to-speech (TTS) system (not shown) that converts a textual representation of the presentation content 180 output from the assistant LLM 150 into synthesized speech. The TTS system is non-limiting and may include a TTS model and/or a vocoder. Thus, the user interface 170 may provide the synthesized speech for audible output from the acoustic speaker 117 of the user device 110. Additionally or alternatively, the assistant LLM 150 may provide visual or graphical representations of the presentation content 180 for output from the user device 110 by displaying text and/or graphics on the screen 112 of the user device 110 responsive to the natural language query 116. In some examples, the visual or graphical representation of the presentation content 180 are provided for output to supplement the synthesized speech of the presentation content 180.

However, in some scenarios, the user 10 provided the natural language query 116 to generate presentation content 180 that the user 10 intends to input into another application 174 executing on the user device 110 or accessible to the user device via the interface 170 (e.g., a web-based interface). Notably, the other application 174 may include a particular format, style, or other constraints of inputs provided by the user 10. Although, since the assistant LLM 150 may or may not have knowledge of the intent of the user 10 to use the presentation content 180 as an input to another application when processing the natural language query 116, the presentation content 180 generated by the assistant LLM 150 may not be suitable for input to the other application 174. For example, the natural language query 116 may request the assistant LLM 150 to generate computer code (e.g., machine-readable code) to perform a functionality. In this example, the assistant LLM 150 may generate the presentation content 180 that includes the computer code to perform the functionality in a first computing language (e.g., Python) since the user 10 did not specify a particular computing language in the natural language query 116. As such, in this example, the user 10 may be unable to directly copy and paste the presentation content 180 that includes the computer code in the first computing language into another application (e.g., programming application) that includes computer code in a second computing language (e.g., C++). In another example, the natural language query 116 may request the assistant LLM 150 to generate a response to an audio message or text message received by the user 10 from another user. Without more, the assistant LLM 150 may generate presentation content 180 that includes a response to the message that includes a textual representation. In this example, a textual representation may not be suitable for the user 10 to input into a texting application for a conversation between the user 10 and the other user that includes audio messages rather than textual messages. Alternatively, the textual representation may be suitable, but the textual representation may not match a conversational style between the user 10 and the other user. As such, the user 10 may be unable to directly copy the presentation content 180 into the texting application. In yet another example, the natural language query 116 may request the assistant LLM 150 to generate presentation content 180 that tells a story about a particular topic. Here, the assistant LLM 150 may generate the story about the particular topic using a textual multi-paragraph representation despite the user 10 intending to input the presentation content 180 into another application 174 that uses text and images. As such, the text-only presentation content 180 may not be directly copied by the user 10 and pasted into the application 174.

To that end, the assistant LLM 150 may be configured to receive a user input indication 172 indicating selection of a target application 174 from among a plurality of applications 174 after generating the presentation content 180. Discussed in greater detail below, the assistant LLM 150 may adapt the presentation content 180 generated by the assistant LLM 150 based on the selected target application 174 such that the assistant LLM 150 may directly input the adapted presentation content 180, 180A into the selected target application 174. Each application 174 of the plurality of applications 174 may be capable of executing on the user device 110 and/or the remote computing system 120. In some examples, the assistant LLM 150 includes a respective application 174 that executes on the user device 110 and/or the remote computing system 120 while receiving the natural language query 116 and/or generating the presentation content 180. Here, the application associated with the assistant LLM 150 may execute in the foreground or background of the user device 110 while receiving the natural language query 116 and generate the presentation content 180. For example, the user 10 may speak a particular hotword or select a particular user interface (UI) element that causes the application associated with the assistant LLM 150 to execute in the foreground of the user device 110 (e.g., display an interactive user interface associated with the assistant LLM 150) or execute in the background of the user device 110 (e.g., execute without displaying the interactive user interface associated with the assistant LLM 150 or displaying a partial interactive user interface associated with the assistant LLM 150) before providing the natural language query 116. The assistant LLM 150 processes the natural language query 116 and the query content 118 (if any) to generate the presentation content 180 for output from the user device 110.

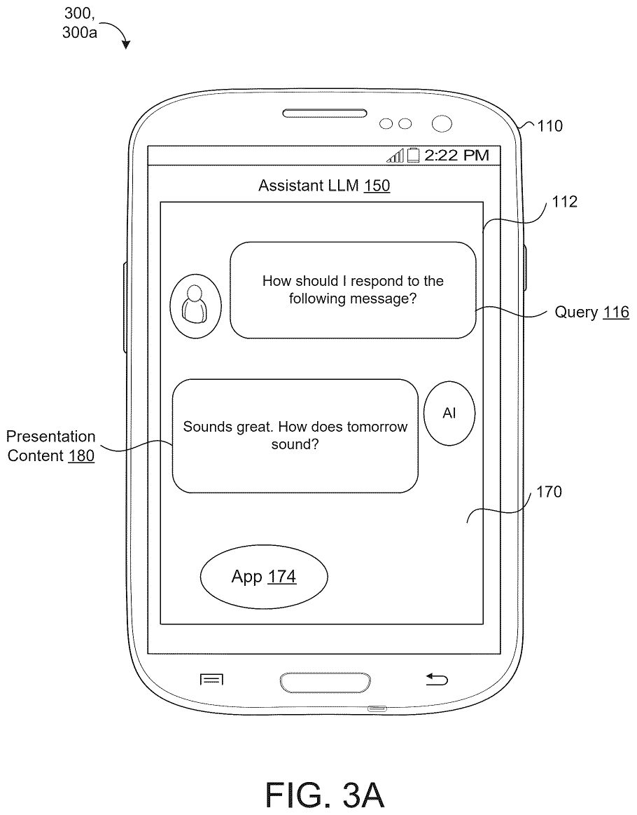

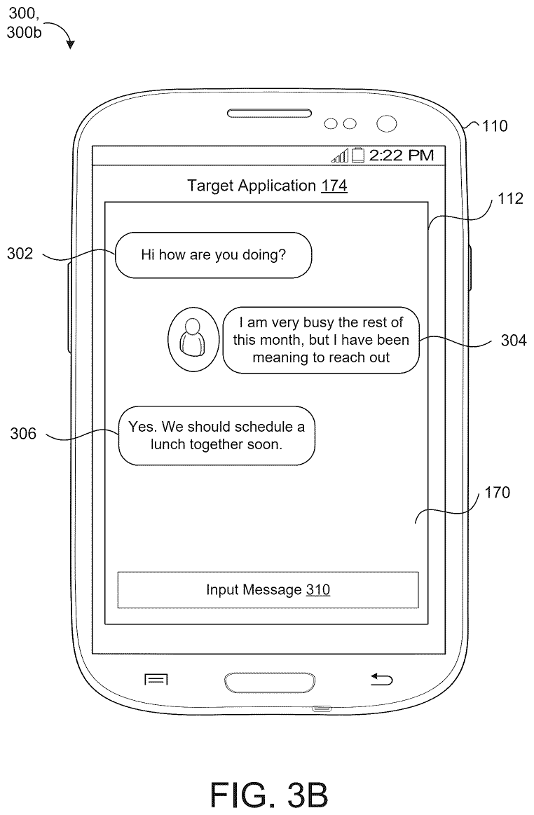

FIG. 3A shows an example schematic view 300, 300a of the screen 112 of the user device 110 displaying an interactive user interface 170 associated with the assistant LLM 150. In the example shown, the interactive user interface of the assistant LLM 150 displays the natural language query 116 provided by the user 10 and the presentation content 180 generated by the assistant LLM 150 and output by the user device 110. In particular, the example shown shows the natural language query 116 of “How should I respond to the following message” and the presentation content 180 of “Sure thing. How does tomorrow sound?” Based on reviewing the presentation content 180 responsive to the natural language query 116, the user 10 may input the user input indication 172 indicating selection of the target application 174 (FIG. 1) that the user 10 intends to input the presentation content 180 into. Notably, the assistant LLM 150 may be unaware of the target application 174 or any context data associated with the target application 174 when generating the presentation content 180.

Referring back to FIG. 1, after generating the presentation content 180, the assistant LLM 150 receives the user input indication 172 indicating the selection of another application 174 different than the application 174 associated with the assistant LLM 150. The user input indication 172 may include selection of another window, tab, or application executing on the user device 110. In response to receiving the user input indication 172, the user device 110 may display the other window, tab, or application on the screen 112 of the user device 110. For example, after the presentation content 180 was output from the user device 110, the user input indication 172 may indicate that the user 10 selected a social media application or a programming application such that the screen 112 of the user device 110 displays the social media application or the programming application. The assistant LLM 150 may adapt the presentation content 180 generated by the assistant LLM 150 based on the user input indication 172 to generate the adapted presentation content 180A and provide the adapted presentation content 180A as input to the target application 174. Notably, the assistant LLM 150 may adapt the presentation content 180 and provide the adapted presentation content 180A for input to the selected target application 174 automatically in response to the user input indication 172 without requiring any additional input from the user 10.

In the example shown, the user 10 speaks the natural language query 116 of “How should I respond to the following message?” which specifies the query content 118 of a prior message from a conversation between the user 10 and another user that includes a sequence of messages in a texting application. The query content 118 may include an audio or textual representation of the prior message. Here, the prior message specified by the query content 118 may include a textual representation of the prior message “Yes. We should schedule a lunch together soon” from a sequence of prior messages. Continuing with the example shown, the assistant LLM 150 processes the natural language query 116 and the query content 118 to generate the presentation content 180 of “Sounds great. How does tomorrow sound?” as a textual representation presented on the screen 112 of the user device 110 (FIG. 3A). Thereafter, the assistant LLM 150 may receive the user input indication 172 from the user interface 170 indicating that the user 10 selected a target application 174 causing the target application 174 to execute on the user device 110 and display contents related to the target application 174 on the screen 112 of the user device 110.

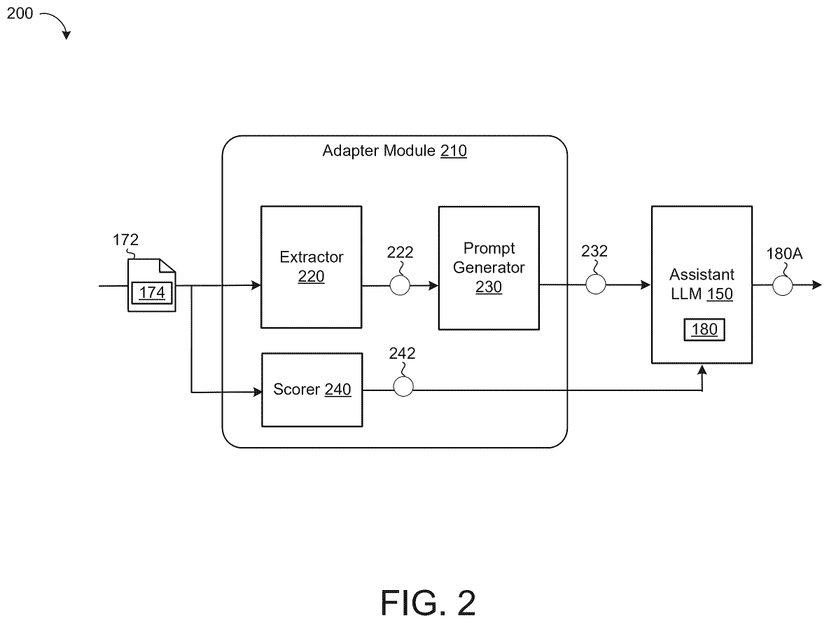

For example, FIG. 3B shows an example schematic view 300, 300b of the screen 112 of the user device 110 displaying an interactive user interface associated with the target application 174 selected by the user 10. In the example shown, the interactive user interface of the target application 174 corresponds to a texting application and prior messages 302, 306 provided by the other user and a prior message 304 provided by the user 10 forming a conversation between the other user and the user 10. In particular, the other user provided the message 302 of “Hi how are you doing?” to which the user 10 responded with the message 304 of “I am very busy the rest of this month, but I have been meaning to reach out” and the other user responded with the message 306 of “Yes. We should schedule a lunch together soon.” As such, the interactive user interface provides a target context 222 (FIG. 2) for the presentation content 180 that was not provided by the natural language query 116 and the assistant LLM 150 was agnostic to when generating the presentation content 180. Notably, since the assistant LLM 150 was unaware of the message 304 by the user 10 indicating that the user 10 is busy for the rest of the month, the presentation content 180 suggesting to meet for lunch tomorrow is uninformed and likely not suitable for the user 10. Moreover, the interactive user interface includes a user interface element 310 corresponding to an input for the target application 174. In the example shown, the user interface element 310 corresponds to the user interface element 310 allowing the user 10 to input a message into the target application 174.

Referring back to FIG. 1, in some implementations, the assistant LLM 150 includes an adapter module 210. Discussed in greater detail with reference to FIG. 2, the adapter module 210 may be configured to determine a target context 222 and/or a prompt 232 to adapt the assistant LLM 150 to generate the adapted presentation content 180. Continuing with the example, the target application 174 selected by the user 10 corresponds to a texting application that causes the texting application to execute on the user device 110 and display contents related to the texting application on the screen 112 of the user device 110 (FIG. 3B). More specifically, the texting application may display a conversation including the entire sequence of messages between the user 10 and another user which includes the query content 118. The entire sequence of messages may include the prior message of the query content 118 and one or more additional prior messages. To that end, the assistant LLM 150 may adapt the presentation content 180 to generate the adapted presentation content 180A based on the selected target application 174. In one example, the selected texting application 174 may indicate that the conversation between the user 10 and another user includes a sequence of audio messages rather than textual messages. Accordingly, in this example, the assistant LLM 150 generates the adapted presentation content 180A by converting the textual representation of the presentation content 180 into corresponding synthetic speech which is input into the texting application and sent to the other user. In another example, the selected texting application 174 may indicate that the conversation between the user 10 and another user includes a context indicating that the user 10 is busy the rest of the month. Thus, in this example, the assistant LLM 150 may generate the adapted presentation content 180A by converting the textual representation of “Sounds great. How does tomorrow sound?” from the presentation content 180 into the textual representation of “Sounds great. How does the second Wednesday of next month sound?” in addition to, or in lieu of, converting the textual representation into a synthetic speech representation. Here, the assistant LLM 150 accommodates the fact that the user 10 is busy for the rest of the month and adapts the originally proposed date of lunch tomorrow to lunch the second Wednesday of next month.

In some implementations, the assistant LLM 150 provides the adapted presentation content 180A for output from the user device 110 before providing the adapted presentation content 180A for input to the selected target application 180A. Put another way, the assistant LLM 150 may provide a preview of the adapted presentation content 180A to the user 10 via the user interface 170 before actually inputting the adapted presentation content 180A to the selected target application 174. The assistant LLM 150 may provide the preview of the adapted presentation content 180A by displaying the adapted presentation content 180A on the screen 112 of the user device 110 and/or audibly outputting the adapted presentation content 180A. As such, the user 10 may confirm or reject the adapted presentation content 180A before the assistant LLM 150 inputs the adapted presentation content 180A into the selected target application 174. Based on the adapted presentation content 180A output from the user device 110, the user 10 may provide, via the user device 110, user feedback 56 which includes a confirmation response that confirms inputting the adapted presentation content 180A into the selected target application 174 or a rejection response that rejects inputting the adapted presentation content 180A into the selected target application 174. Thus, the assistant LLM 150 may provide the adapted presentation content 180 for input to the selected target application 174 based on receiving the confirmation response from the user device 110. On the other hand, the assistant LLM 150 may refrain from providing the adapted presentation content 180A for input to the selected target application based on receiving the rejection response from the user device 110.

In some implementations, the user 10 provides a follow-on query 119 specifying one or more refinement actions for the assistant LLM 150 to perform to refine the adapted presentation content 180A output from the user device 110. The user 10 may provide the follow-on query 119 as a textual input or a spoken input that is transcribed by the ASR system 140 and provided as input to the assistant LLM 150. The assistant LLM 150 may process the adapted presentation content 180A and the follow-on query 119 to generate refined presentation content 180, 180R and provide the refined presentation content 180R for input to the selected target application 174. In particular, the assistant LLM 150 may concatenate the adapted presentation content 180A and the follow-on query 119 and generate the refined presentation content 180R by processing the concatenation. With respect to the example shown, the user 10 may provide the follow-on query 119 of “lunch is generally not good for me, propose a time in the morning for coffee instead” in response to the adapted presentation content 180A being output from the user device 110. Here, the assistant LLM 150 may process the concatenation of the adapted presentation content 180A and the follow-on query 119 to generate the refined presentation content 180R corresponding to “Instead of lunch, how does coffee in the morning on the second Wednesday of next month sound?” and provide the refined presentation content 180R as input into the texting application.

Advantageously, the assistant LLM 150 may generate initial presentation content 180 based on the natural language query 116 provided by the user 10. As discussed above, the presentation content 180 may not be suitable for input to a target application 174 the user 10 intends to input the presentation content 180, or some variation thereof, into because the assistant LLM 150 may be unaware of the intent of the user 10. As such, by monitoring user inputs by the user 10 after generating the presentation content 180, the assistant LLM 150 may discern an intent by the user 10 for using the presentation content 180 and adapt the presentation 180 to be suitable for such intent. Thus, the assistant LLM 150 may adapt the presentation content 180 without requiring the user 10 to provide detailed natural language queries 116 yet is still able generate suitable outputs that are able to be directly input into a target application 174.

In some implementations, the natural language query 116 further specifies the target application 174 that the user 10 intends to input the presentation content 180 into. For example, the natural language query 116 may include “generate a response to this message for input into a texting application.” Here, the assistant LLM 150 may generate the presentation content 180 initially based on the target application 174 specified in the natural language query 116 such that the initial presentation content 180 is suitable, or more suitable, to input into the target application 174 than presentation content 180 by the assistant LLM 150 without knowing the target application 174 for the presentation content 180. Yet, even when the natural language query 116 specifies the natural language query 116, the assistant LLM 150 may adapt the presentation content 180 based on the target context 222 of the target application 174 derived by the adapter module 210.

The example shown in FIG. 1 is exemplary only as it is understood that the assistant LLM 150 may adapt the presentation content 180 to conform to any target context 222 (FIG. 2) of any target application 174. For example, in another scenario the texting application may indicate a conversation between the user 10 and another user in a different language than the natural language query 116. In this scenario, the user 10 may issue the natural language query 116 in English, and thus, the assistant LLM 150 may generate the presentation content 180 in English. Continuing with this scenario, the assistant LLM 150 may determine that the selected target application 174 indicates a conversation between the user 10 and another user in Spanish rather than English. As such, the assistant LLM 150 may adapt the presentation content 180 from the English to Spanish and input the adapted presentation content 180A into the selected target application 174. After inputting the adapted presentation content 180A into the selected target application 174, the assistant LLM 150 may extract metadata and/or data from the selected target application 174 to determine whether the input of the adapted presentation content 180A was successful or not. If the assistant LLM 150 determines the adapted presentation content 180A was not input successfully, the assistant LLM 150 may provide an indication of the failed input attempt to the assistant LLM 150 such that the assistant LLM 150 generates new presentation content 180 that is capable of successfully inputting into the target application.

FIG. 2 illustrates a schematic view 200 of the adapter module 210 of the assistant LLM 150 determining a prompt 232 based on the user input indication 172 indicating a selection of the target application 174. The adapter module 210 may include an extractor 220 and a prompt generator 230. The extractor 220 is configured to receive the user input indication 172 indicating the target application 174 selected by the user 10 after generating the presentation content 180 and extract the target context 222 for inputting the presentation content 180 into the selected target application 174. The target context represents contextual information of the selected target application 174 that informs the assistant LLM 150 of any particular formatting, style, or other constraints preferred or required by the target application 174. For instance, the extractor 220 may extract metadata from the target application 174 that indicates operating characteristics of the target application, for example, a preferred language, style, or output modality of the presentation content 180. A programming environment may be specific to a particular programming language such that the metadata extracted from the programming environment indicates to the assistant LLM 150 the particular programming language the programming environment is suited for. The extracted style from the target application 174 may indicate a textual style or audio style of the presentation content 180. For instance, a social media application may indicate a textual style that is informal, concise, and includes hashtags while an information engine application may indicate a more formal textual style. Moreover, the output modality of the target application 174 may indicate whether the target application 174 prefers textual inputs, audio inputs, and/or image inputs. As such, the output modality may indicate to the assistant LLM 150 whether the assistant LLM 150 should adapt the presentation content 180 from a first modality to one or more other modalities compatible with the selected target application 174.

In some examples, the extractor 220 extracts text associated with the target application 174. That is, the extractor 220 may extract text currently displayed by the target application 174 to the user 10 via the user device 110. Here, the target context 222 may include all of the extracted text or a summary of the extracted text. In some examples, the extractor 220 uses an auxiliary LLM to summarize the extracted text to generate the target context. With reference to the example shown in FIG. 1, the extractor 220 may extract the target context 222 which includes the conversation between the user 10 and the other user and a textual context or an audio context for inputting the presentation content to the selected target application. More specifically, the presentation content 180 may include a textual representation or a synthetic speech representation and the target context 22 may indicate the target application 174 prefers the textual representation or the synthetic speech representation. Although not shown, the extractor 220 may input the target context 222 directly to the assistant LLM 150 such that the assistant LLM 150 generates the adapted presentation content 180A based on the presentation content 180 and the target context 222.

In some implementations, the extractor 220 transmits the target context 22 to the prompt generator 230 which is configured to generate a prompt 232 that guides the assistant LLM 150 to generate the adapted presentation content 180A. For example, when the presentation content 180 includes a textual representation and the target context 222 indicates that the target application 174 prefers a synthetic speech representation, the prompt generator 230 may generate the prompt 232 of “The target context needs an audio input, please provide it using audio sample {audio} and the presentation content.” Thus, by processing the prompt 232 generated by the prompt generator 230, the assistant LLM 150 generates the adapted presentation input 180A based on the prompt 232. In another example, the presentation content 180 may include a textual representation and the target context 222 indicates that the target application 174 prefers a textual speech representation with a formal textual style. Here, the prompt generator 230 may generate the prompt 232 of “The target context needs formal textual output, please provide it using a formal textual style and the presentation content.” Thus, by processing the prompt 232, the assistant LLM 150 may generate the adapted presentation content 180A which includes a textual representation with a formal textual style rather than an informal textual style associated with the presentation content 180.

In some implementations, the adapter module 210 includes a scorer 240 configured to determine whether the target application 174 selected by the user input indication 172 is associated with the presentation content 180. Put another way, the scorer 240 determines whether the user 10 intends to input the presentation content 180 or adapted presentation content 180A into the target application 174 or whether the target application 174 is unrelated to the presentation content. As such, the scorer 140 may obtain data representing the selected target application 174 displayed on the screen 112 of the user device 110 based on receiving the user input indication 172 from the user device 110. Here, the scorer 140 may obtain the data by extracting text from the selected target application 174 displayed on the screen 112 of the user device 110 or extracting metadata from one or more user interface elements of the selected target application displayed on the screen 112 of the user device 110. Based on the obtained data, the scorer may determine a score 242 indicating a likelihood that the user 10 intends to input the presentation content 180 or the adapted presentation content 180A to the selected target application 174. The assistant LLM 150 may receive the score 242 generated by the scorer 240 and determine whether the score 242 satisfies a threshold. In some examples, the assistant LLM 150 generates the adapted presentation content 180A based on determining that the score 242 satisfies the threshold and/or inputs the adapted presentation content 180A for input to the selected target application 174 based on determining that the score 242 satisfies the threshold. In some examples, the assistant LLM 150 or another auxiliary LLM generates a classification indicating whether the presentation content 180 generated by the assistant LLM 150 corresponds to the target application 174 selected by the user 10. Here, the scorer 240 may determine the score 242 further based on the classification generated by the assistant LLM 150 or the auxiliary LLM. For instance, with respect to the example shown in FIG. 1, the LLM may generate the classification of “this response is a typical response used in a texting application or email application” based on processing the presentation content 180. As such, the scorer 240 may compare the classification to the selected target application 274 when determining the score 242.

Advantageously, the assistant LLM 150 provides a more useful and convenient way for users 10 to leverage outputs from LLMs (e.g., presentation content 180) across different applications and contexts. In particular, presentation content 180 generated by the assistant LLM 150 may be adapted to be suitable for input to a target application corresponding to an application for writing software code, a social media application, or an information gathering application. In particular, the assistant LLM 150 enables the user 10 obtain an initial answer (e.g., presentation content 180) from the assistant LLM 150 in one application or browser tab (FIG. 3A) and then the assistant LLM 150 adapts the initial answer to fit a target context of another application or browser tab selected by the user 10 after the initial answer is generated. Adapting the initial answer may include adjusting the format, style, or language of the initial answer to be compatible with the target context 222 of the target application 174. The assistant LLM 150 may adapt the initial answer by analyzing the intent of the user 10 and content or metadata of the other application or tab the user 10 selected. Moreover, the assistant LLM 150 may provide the user 10 with an option to insert the adapted answer or to directly modify or propose modification for the assistant LLM 150 to make on the adapted answer before inserting the adapted answer into the target application 174.

In some configurations, the assistant LLM 150 may perform one or more transformations on the initial answer, such as changing the modality of the answer (e.g., from text to audio, audio to text, text to text and images, etc.), the language, tone, format, and content of the answer. In some implementations, the assistant LLM 150 splits the adapted presentation content 180A into one or more sections and inserts each section of the adapted presentation content 180A into the target application. For example, the adapted presentation content 180A may include a sequence of text for filling out an interactive form of a target application with multiple interactive text boxes. In this example, the adapted presentation content 180A may include text for all the interactive text boxes whereby the user may not intend to insert the entirety of the adapted presentation content 180A into each interactive text box. Thus, the assistant LLM 150 may split the adapted presentation content 180A into one or more sections and insert each section of the adapted presentation content 180A into a corresponding location of the target application. Continuing with the above example, the assistant LLM 150 may split the text of the adapted presentation content 180A into one or more sections such that each section corresponds to one of the interactive text boxes. As such, the assistant LLM 150 may insert each section into a corresponding text box individually or in parallel.

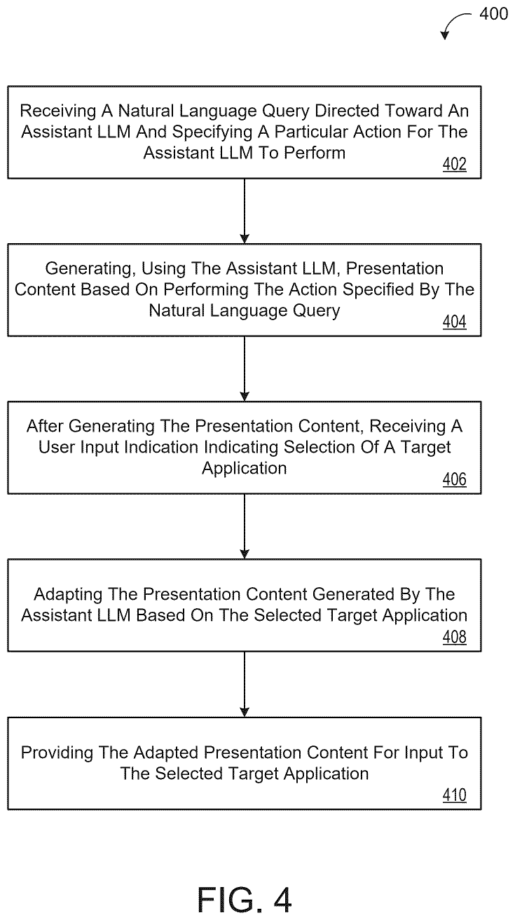

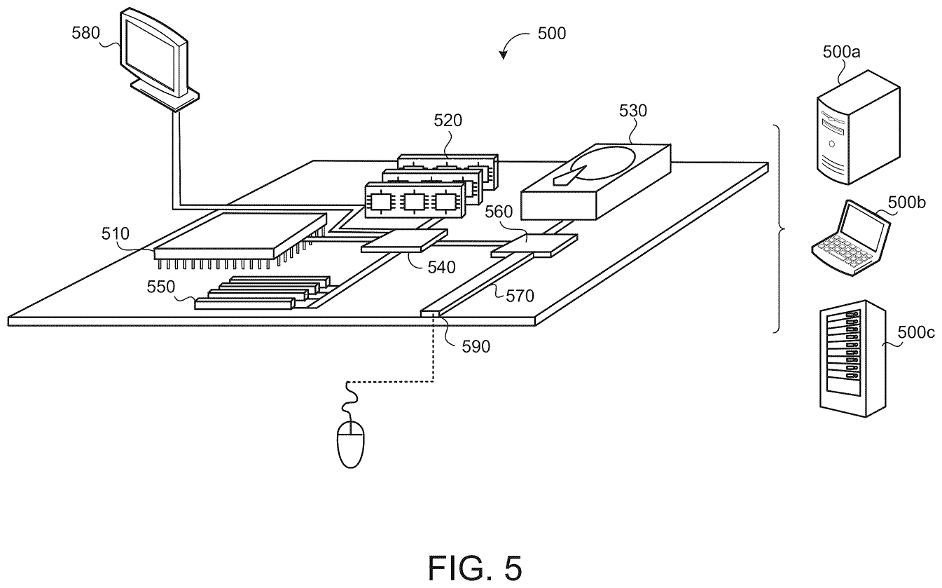

FIG. 4 illustrates a flowchart of an example flowchart of operations for a computer-implemented method 400 of adapting LLM answers. The method 400 may execute on data processing hardware 510 (FIG. 5) using instructions stored on memory hardware 520 (FIG. 5) that may reside on the user device 110 and/or the remote computing system 120 of FIG. 1 each corresponding to a computing device 500 (FIG. 5).

At operation 402, the method 400 includes receiving a natural language query 116 directed toward an assistant LLM 150 from a user device 110 associated with a user 10. The natural language query 116 specifies a particular action for the assistant LLM 150 to perform. For example, the particular action may include generating a caption for an image or generating code to perform a particular functionality for an application. The natural language query 116 may be spoken by the user 10 and/or provided as a textual input by the user 10. Moreover, the natural language query 116 may specify or include query content 118 associated with the action specified by the natural language query 116. For instance, the query content 118 may include audio data or image data associated with the action specified by the natural language query 116. At operation 404, the method 400 includes generating, using the assistant LLM 150, presentation content 180 based on performing the action specified by the natural language query 116. At operation 406, the method 400 includes receiving a user input indication 172 from the user device 110 after generating the presentation content 180. The user input indication 172 may indicate a selection of an application. At operation 408, the method 400 includes adapting the presentation content 180 generated by the assistant LLM 150 based on the selected application. At operation 410, the method 400 includes providing the adapted presentation content 180A for input to the selected application.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving, from a user device associated with a user, a natural language query directed toward an assistant large language model (LLM), the natural language query specifying a particular action for the assistant LLM to perform;
generating, using the assistant LLM, presentation content based on performing the action specified by the natural language query;
after generating the presentation content, receiving, a user input indication from the user device, the user input indication indicating selection of a target application;
adapting the presentation content generated by the assistant LLM based on the selected target application; and
providing the adapted presentation content for input to the selected target application.

2. The computer-implemented method of claim 1, wherein the operations further comprise:
extracting, from the selected target application, a target context for inputting the presentation content into the selected target application; and
determining a prompt for input to the assistant LLM based on the presentation content and the target context,
wherein adapting the presentation content comprises processing, using the assistant LLM, the prompt to generate the adapted presentation content.

3. The computer-implemented method of claim 2, wherein:
the presentation content comprises a textual representation;
the target context indicates an audio context for inputting the presentation content to the selected target application; and
the adapted presentation content comprises a synthetic speech representation.

4. The computer-implemented method of claim 3, wherein the assistant LLM comprises a multimodal LLM.

5. The computer-implemented method of claim 2, wherein:
the presentation content comprises a textual representation;
the target context indicates a textual context for inputting the presentation content to the selected target application; and
the adapted presentation content comprises another textual representation different than the textual representation of the presentation content.

6. The computer-implemented method of claim 1, wherein the operations further comprise:
before providing the adapted presentation content for input to the selected target application, providing the adapted presentation content for output from the user device;
receiving a follow-on query specifying one or more refinement actions for the adapted presentation content;
generating refined presentation content based on the adapted presentation content and the follow-on query, and
providing the refined presentation content for input to the selected target application.

7. The computer-implemented method of claim 6, wherein generating the refined presentation content comprises processing, using the assistant LLM, a concatenation of the adapted presentation content and the follow-on query.

8. The computer-implemented method of claim 1, wherein the operations further comprise:
before providing the adapted presentation content for input to the selected target application, providing the adapted presentation content for output from the user device; and
receiving a confirmation response from the user device confirming input of the adapted presentation content into the selected target application,
wherein providing the adapted presentation content for input to the selected target application is based on receiving the confirmation response from the user device.

9. The computer-implemented method of claim 1, wherein the natural language query further specifies the target application for the presentation content.

10. The computer-implemented method of claim 1, wherein the operations further comprise:
based on receiving the user input indication from the user device, obtaining data representing the selected target application displayed on a screen of the user device;
determining a score indicating a likelihood that the user intends to input the presentation content to the selected target application based on the obtained data representing the selected target application; and
determining that the score satisfies a threshold,
wherein providing the adapted presentation content for input to the selected target application is based on determining that the score satisfies the threshold.

11. The computer-implemented method of claim 10, wherein obtaining the data representing the selected target application comprises at least one of:
extracting text from the selected target application displayed on the screen of the user device; or
extracting metadata from one or more user interface elements of the selected target application displayed on the screen of the user device.

12. A system comprising:
data processing hardware; and
memory hardware in communication with the data processing hardware, the memory hardware storing instructions that when executed on the data processing hardware cause the data processing hardware to perform operations comprising:
receiving, from a user device associated with a user, a natural language query directed toward an assistant large language model (LLM), the natural language query specifying a particular action for the assistant LLM to perform;
generating, using the assistant LLM, presentation content based on performing the action specified by the natural language query;
after generating the presentation content, receiving, a user input indication from the user device, the user input indication indicating selection of a target application;
adapting the presentation content generated by the assistant LLM based on the selected target application; and
providing the adapted presentation content for input to the selected target application.

13. The system of claim 12, wherein the operations further comprise:
extracting, from the selected target application, a target context for inputting the presentation content into the selected target application; and
determining a prompt for input to the assistant LLM based on the presentation content and the target context,
wherein adapting the presentation content comprises processing, using the assistant LLM, the prompt to generate the adapted presentation content.

14. The system of claim 13, wherein:
the presentation content comprises a textual representation;
the target context indicates an audio context for inputting the presentation content to the selected target application; and
the adapted presentation content comprises a synthetic speech representation.

15. The system of claim 14, wherein the assistant LLM comprises a multimodal LLM.

16. The system of claim 13, wherein:
the presentation content comprises a textual representation;
the target context indicates a textual context for inputting the presentation content to the selected target application; and
the adapted presentation content comprises another textual representation different than the textual representation of the presentation content.

17. The system of claim 12, wherein the operations further comprise:
before providing the adapted presentation content for input to the selected target application, providing the adapted presentation content for output from the user device;
receiving a follow-on query specifying one or more refinement actions for the adapted presentation content;
generating refined presentation content based on the adapted presentation content and the follow-on query; and
providing the refined presentation content for input to the selected target application.

18. The system of claim 17, wherein generating the refined presentation content comprises processing, using the assistant LLM, a concatenation of the adapted presentation content and the follow-on query.

19. The system of claim 12, wherein the operations further comprise:
before providing the adapted presentation content for input to the selected target application, providing the adapted presentation content for output from the user device; and
receiving a confirmation response from the user device confirming input of the adapted presentation content into the selected target application,
wherein providing the adapted presentation content for input to the selected target application is based on receiving the confirmation response from the user device.

20. The system of claim 12, wherein the natural language query further specifies the target application for the presentation content.

21. The system of claim 12, wherein the operations further comprise:
based on receiving the user input indication from the user device, obtaining data representing the selected target application displayed on a screen of the user device;
determining a score indicating a likelihood that the user intends to input the presentation content to the selected target application based on the obtained data representing the selected target application; and
determining that the score satisfies a threshold,
wherein providing the adapted presentation content for input to the selected target application is based on determining that the score satisfies the threshold.

22. The system of claim 21, wherein obtaining the data representing the selected target application comprises at least one of:
extracting text from the selected target application displayed on the screen of the user device; or
extracting metadata from one or more user interface elements of the selected target application displayed on the screen of the user device.
